(19) United States
(12) Patent Application Publication
(10) Pub. No.: US 2013/0078430 A1
(43) Pub. Date: Mar. 28, 2013

(54) DECAL ASSEMBLY FOR REPAIRING OR REPLACING SIGNAGE AND METHOD OF USE THEREOF

(71) Applicant: Jarado Blue, Rancho Cucamonga, CA (US)

(72) Inventor: Jarado Blue, Rancho Cucamonga, CA (US)

(21) Appl. No.: 13/428,160

(22) Filed: Mar. 23, 2012

Related U.S. Application Data
(60) Provisional application No. 61/540,456, filed on Sep. 28, 2011.

(51) Int. Cl. B32B 3/00; B23P 6/00

(52) U.S. Cl. 428/195.1; 29/402.01

(57) ABSTRACT

A decal assembly designed and configured for repairing or replacing a sign comprises a decal, having a front side that incorporates a display and a back side that is coated with an adhesive, and one or more pieces of backing material covering and protecting the adhesive on the back side of the decal. To use the decal assembly, the backing material is peeled from the back side of the decal, the back side of the decal is aligned with, then pressed and adhered onto the front side of a sign that is to be repaired or replaced.

### CROSS-REFERENCE TO RELATED APPLICATIONS

This application claims the benefit of and is a continuation of prior U.S. Provisional Application No. 61/540,456, filed 27 Sep. 2011.

### BACKGROUND OF THE INVENTION

The present invention generally relates to the field of signage. More particularly, an embodiment of the present invention provides a useful and novel device for the repair of damaged signs, and a method of use thereof.

Repair and replacement of signage is a significant issue, particularly for local, state, and federal governmental entities. Signs may be damaged by graffiti or vandalism, or by weather and other natural forces. Signs may also require repair or replacement simply because they have reached the end of their useful lives. In addition, there exists a need to place temporary signage, such as in the case of marking a detour. Further, there exists a need to place redirected signage, such as in the case of a change in the laws and/or ordinances that regulate the form or content of the signage.

Conventional methods of repairing damaged signage include removal of graffiti by means of chemical solvents, re-painting or repairing the damaged signage, or total replacement of the signage. The use of chemical solvents exposes workers and the environment to caustic chemicals. Repainting or repairing signage is time consuming and expensive, requiring teams of people, equipment and materials. Replacing signage is also expensive. In the United States, each street sign generally costs between $100 and $500 to replace. [Source: Street Sign Theft; http://en.wikipedia.org/wiki/Street_sign_theft, accessed 1 Mar. 2012] Street sign repair is time consuming and costly as well, requiring teams of people and equipment. Further, the practice of completely and prematurely discarding damaged or obsolete signage results in the wasteful assignment of signs, signposts and mounting hardware to landfills.

Conventional methods of placing temporary and redirected signage include mounting the temporary and/or redirected signage over the face of the existing signage, or installation of a new sign.

It is important to repair and/or replace signage quickly. In the case of temporary signage, action must often be taken quickly in response to an emergency situation. In the case of graffiti or vandalism, research shows that the immediate removal or repair of damaged signage operates as a disincentive to vandalism.

As can be seen, there is a need for a device and method for repairing and/or replacing signage that reduces the time and cost of repair and/or replacement, and that accomplished the task in a safe and eco-friendly manner.

### SUMMARY OF THE INVENTION

In view of the limitations and disadvantages inherent to conventional means of repairing and replacing signage, it is an object of the present invention to provide a device and method for repairing and/or replacing signage that reduces the time and cost of repair and/or replacement, and that accomplished the task in a safe and eco-friendly manner.

According to one aspect of the present invention, a decal assembly designed and configured for repairing or replacing a sign comprises a decal, having a front side that incorporates a display and a back side that is coated with an adhesive, and one or more pieces of backing material covering and protecting the adhesive on the back side of the decal. In this aspect, the present invention provides a device that is inexpensive to produce, and that may be quickly and inexpensively utilized.

According to another aspect of the present invention, to use the decal assembly, the backing material is peeled from the back side of the decal, the back side of the decal is aligned with, then pressed and adhered onto the front side of a sign that is to be repaired or replaced. In this aspect, the present invention provides a method may be quickly and inexpensively practiced in a safe and eco-friendly manner.

These and other objects, features, aspects and advantages of the present invention will become apparent to those with skill in the art from the following figures, descriptions and claims. As will be appreciated by those with skill in the art, the method of the present invention may be implemented in a plurality of equivalent steps, and the device may be implemented in a plurality of equivalent embodiments. Such alternative method steps and device embodiments, and their attendant objects, aspects and advantages, are within the scope of the present invention and, therefore, the examples set forth herein shall not be limiting.

### BRIEF DESCRIPTION OF THE DRAWINGS

The nature of this invention, as well as all its objects, aspects and advantages, will become readily apparent and understood upon reference to the following detailed description when considered in conjunction with the accompanying drawings, in which like reference numerals designate like parts throughout the figures thereof, and wherein:

FIG. 1 presents front and back views of a decal assembly, according to an exemplary embodiment of the invention;

FIG. 2 presents a flow diagram of a method of using the decal assembly FIG. 1, according to an exemplary embodiment of the invention;

FIG. 3 presents a perspective view illustrating the installation of the decal of FIG. 1 over a damaged sign, according to an exemplary embodiment of the invention;

FIG. 4 presents a perspective view illustrating the installation of the decal of FIG. 1 over a sign that is to be replaced, according to an exemplary embodiment of the invention; and

FIG. 5 presents a perspective, exploded view illustrating the installation of a decal assembly, according to an exemplary embodiment of the invention.

### DETAILED DESCRIPTION OF THE INVENTION

The following description is provided to enable any person skilled in the art to make and use the invention, and sets forth the best modes contemplated by the inventor of carrying out the invention. The present invention shall not be limited to the examples disclosed. Rather, the scope of the invention shall be as broad as the claims will allow.

Various inventive features are described below that can each be used independently of one another or in combination with other features. However, any single inventive feature may not address any of the problems discussed above, or may only address one of the problems discussed above. Further, one or more of the problems discussed above may not be fully addressed by any of the features described below.

Broadly, embodiments of the present invention generally provide an improved device and method that minimize the time and expense associated with the repair and/or replacement of signage, while enabling repair and/or replacement to be performed in a safe and eco-friendly manner. More specifically, the device (hereinafter “decal assembly”) and method of the present invention are an improvement over conventional devices and methods of repairing and/or replacing signage. The decal assembly provides a decal that may be adhered to the face of a damaged sign, or to the face of a sign that requires modification, in order to effect a quick and inexpensive repair.

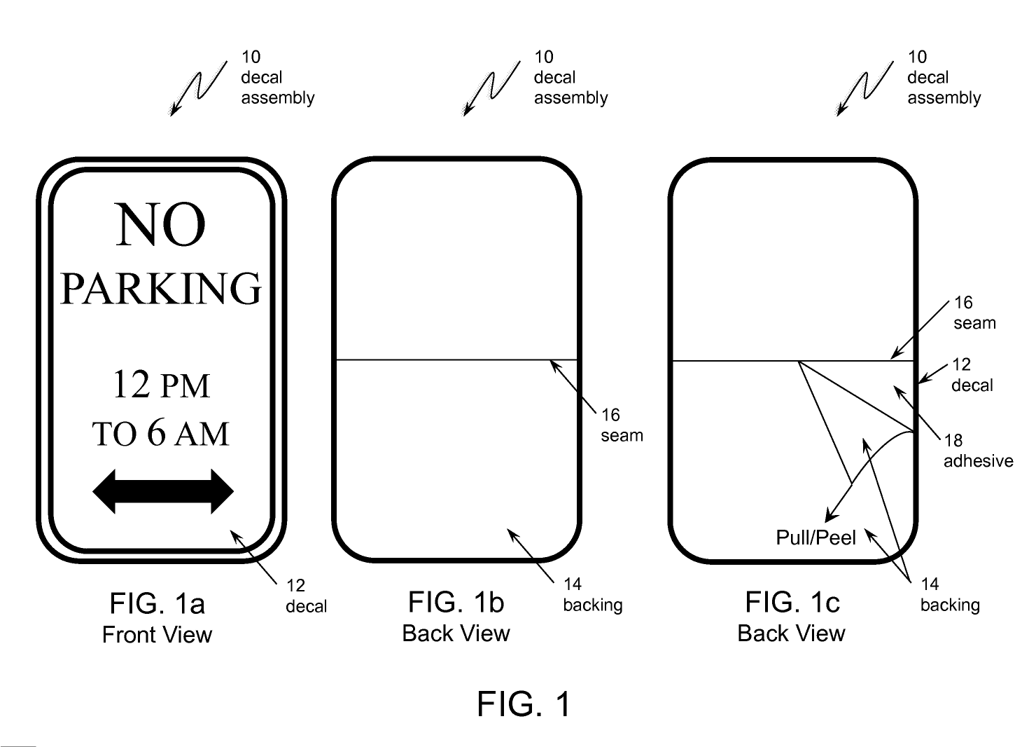

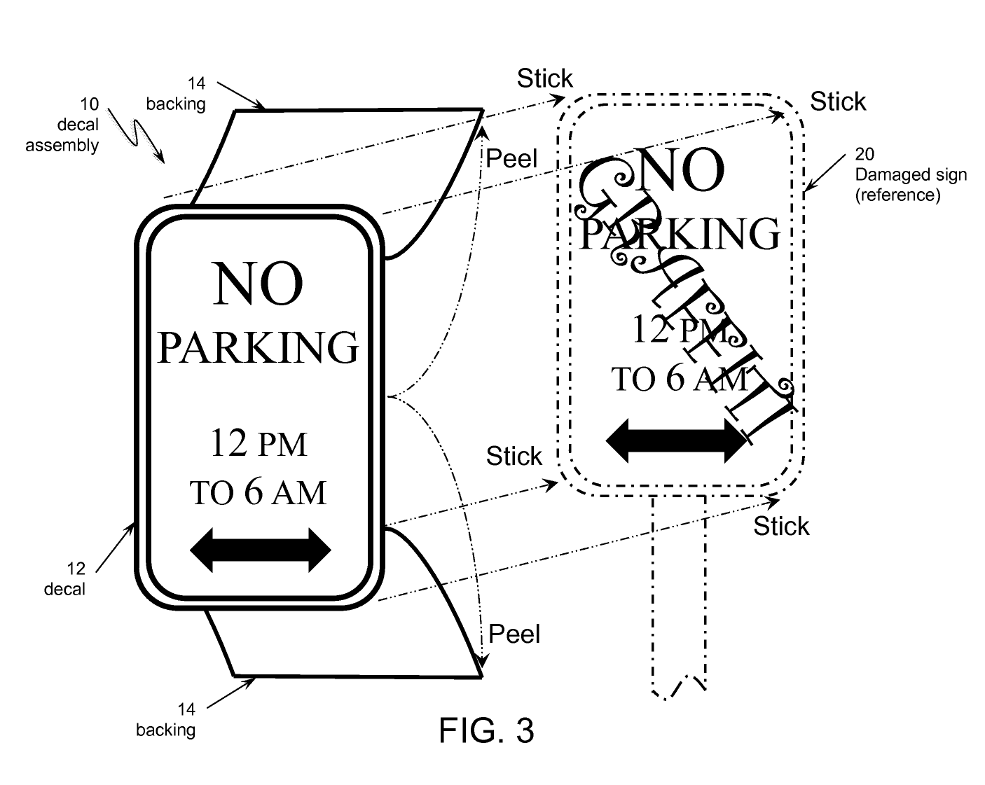

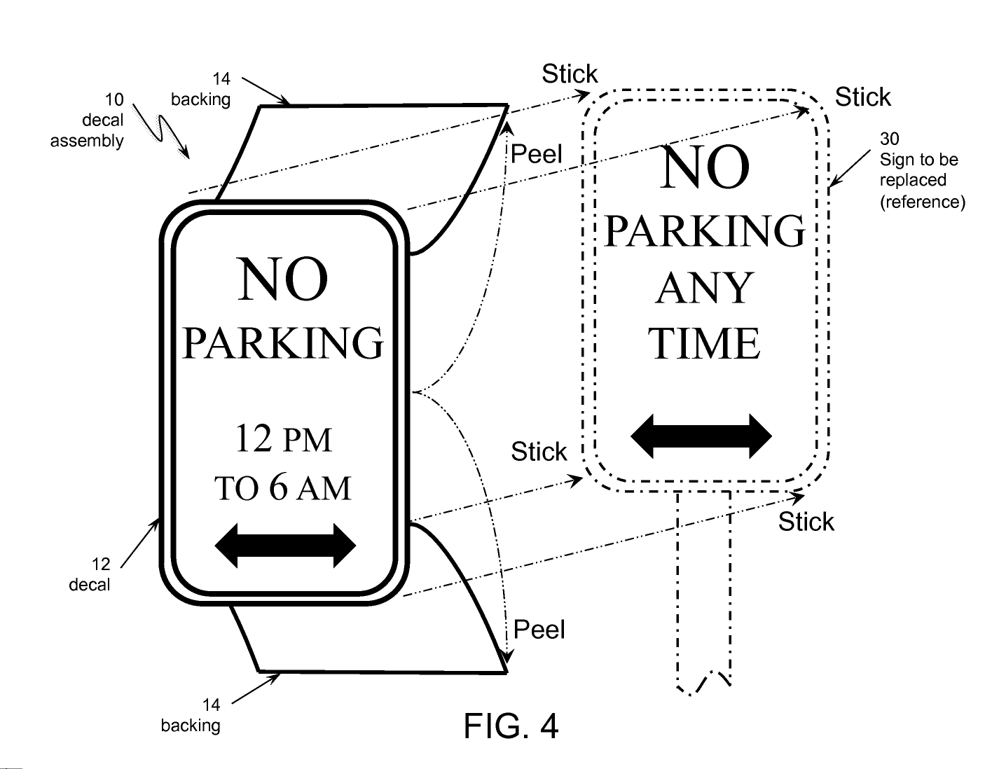

Referring now to the drawings, FIG. 1 presents front and back views of a decal assembly 10 according to an exemplary embodiment of the invention. The decal assembly 10 may comprise a decal 12 and backing 14. The decal 12 may be made of a flexible material, such as plastic, vinyl, or paper, or the decal 12 may be made of a rigid material such as plastic, cardboard, or metal. The decal 12 may be sized to fit the face of a damaged sign 20, as illustrated in FIG. 3, or to fit the face of a sign 30 that is to be replaced, as illustrated in FIG. 4. Large signs may be replaced in fractional sections so that only the damaged portion need be replaced.

The front side of the decal 12 may display a replica of the original display of a damaged sign 20. Alternatively, the front of the decal 12 may incorporate a display that is intended to replace an existing sign 30. The back side of the decal 12 may be coated with an adhesive 18 designed to secure the decal 12 onto the face of a damaged sign 20 or a sign 30 to be replaced. The backing 14 may be designed to protect the adhesive 18 on the back of the decal 12 prior to installation of the decal 12 onto the damaged sign 20 or sign to be replaced 30. The backing 14 may be made of a nonstick paper or plastic material that is specially prepared and designed to allow the backing 14 to be peeled off of the decal 12. The backing 14 may comprise one or more separate pieces. Where the backing comprises a plurality of piece, one or more seams 16 may be formed where the plurality of pieces abut one another. The one or more seams 16 may facilitate removal of the backing 14 from the decal 12.

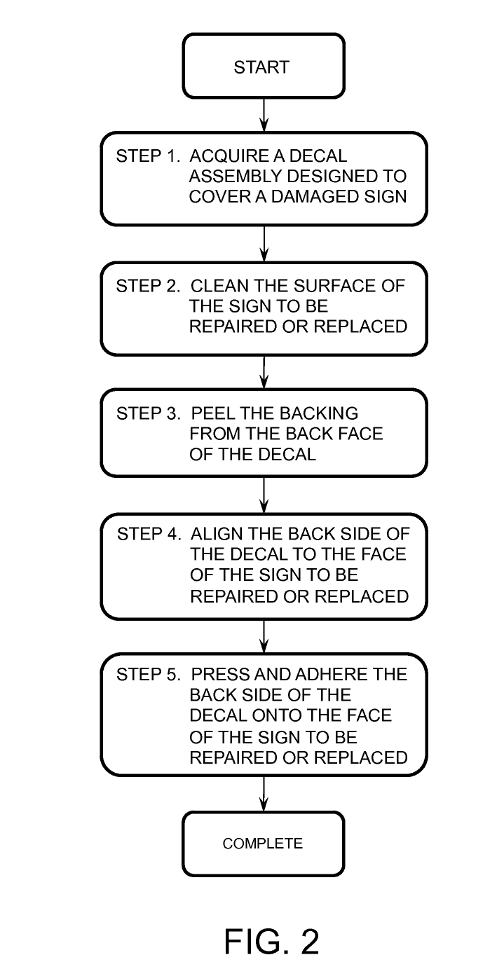

FIG. 2 presents a flow diagram of a method of using the decal assembly, according to an exemplary embodiment of the invention. The method may comprise the following steps. The steps may be performed in the field, at the location of the sign to be repaired or replaced.
Step 1. Acquire a decal assembly 10.
Step 2. Optionally, clean the surface of a sign to be repaired 20 or replaced 30 in order to ensure that the decal 12 will adhere to the surface.
Step 3. Peel the one or more pieces of backing 14 from the back side of the decal 12, thereby exposing the adhesive 18, as illustrated in FIG. 1.
Step 4. Align the back side of the decal 12 to the face of the sign to be repaired 20 or replaced 30, as illustrated in FIG. 3 and FIG. 4.
Step 5. Press and adhere the back side of the decal 12 onto the face of the sign to be repaired 20 or replaced 30, as illustrated in FIG. 3 and FIG. 4.

In an alternative embodiment of the method, a Step 2A may be added to the process, either prior to or after Step 2. In Step 2A, the decal 12 may be scored or cut with a sharp instrument, such as a razor, knife or scalpel, to provide one or more openings through the decal 12 where necessary to provide clearance for hardware protruding from an existing sign, such as bolts. The openings may be of any appropriate configuration, such as a circular hole, a linear slit, or a pair of slits in the shape of an “X”.

FIG. 3 presents a perspective view illustrating the installation of a decal 12 of over a damaged sign 20, according to an exemplary embodiment of the invention.

FIG. 4 presents a perspective view illustrating the installation of a decal 12 of FIG. 1 over a sign that is to be replaced 30, according to an exemplary embodiment of the invention.

In an alternative embodiment, all or selected portions of the face of the decal 12 may be made of retroreflective and/or prismatic materials, particularly as required for compliance with Occupational Safety & Health Administration (OSHA) and American National Standards Institute (ANSI) standards.

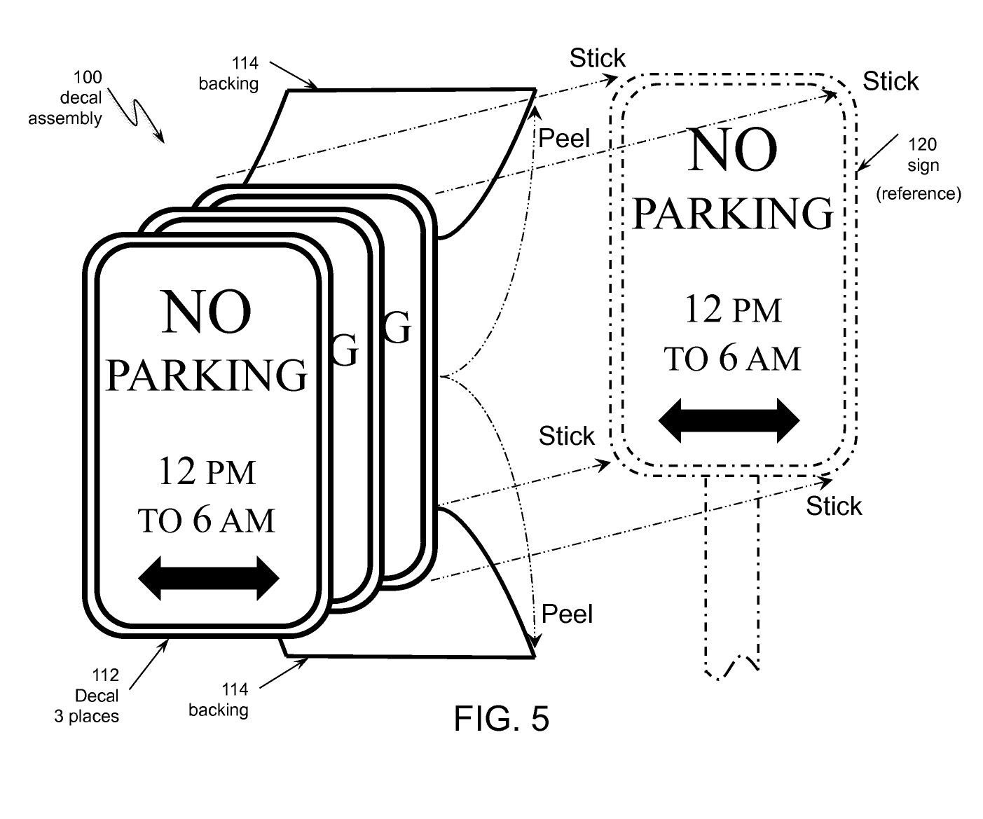

FIG. 5 presents a perspective, exploded view illustrating the installation of a decal assembly 100, according to an exemplary embodiment of the invention. In this alternative embodiment, the decal assembly 100 may comprise a plurality of decals 112 and backing 114. The front side of each decal 112 may have a display. The back side of each decal 112 may be coated with adhesive. The adhesive may be selected as appropriate for either permanent or temporary installations. Multiple decals 112 may be stacked, one upon another, such that multiple decals 112 are in place on the face of a sign 120. When the topmost decal 112 is damaged or has reached the end of its useful life, the topmost decal 112 may be peeled off of the top of the stack of decals 112, thereby refreshing the sign with the undamaged display of the newly-uncovered decal 112. The back side of the back-most decal 112 may be covered, prior to installation, with one or more pieces of backing 114 to protect the adhesive prior to installation on the sign 120. The stack of decals 112 may be installed on the sign 120 by peeling the backing 114 from the back side of the back-most decal 112, aligning the stack of decals 112 with the face of the sign 120, and pressing and adhering the back side of the back-most decal 112 to the face of the sign 120.

It should be understood, of course, that the foregoing relates to exemplary embodiments of the invention, and that modifications may be made without departing from the spirit and scope of the invention as set forth in the following claims. The individual steps of the disclosed method may be modified, interchanged, separated or combined, or additional steps added without departing from the spirit of the invention. Further, the elements of the device may be modified, interchanged, separated or combined, or additional elements added without departing from the spirit of the invention. The invention may be practiced in alternative embodiments other than those illustrated in the Figures. Such modifications, combinations, additions and alternatives are within the contemplation of the present invention. The exemplary method and embodiments disclosed are not intended to limit the scope of this invention. Accordingly, the scope of the invention should be determined not by the embodiments illustrated, but by their legal equivalents, and shall be as broad as the claims will allow.

What is claimed is:

1. A decal assembly for repairing or replacing a sign, comprising:
a decal having a front side and a back side, said front side having a display and said back side coated with an adhesive; and
one or more pieces of backing material covering said back side of said decal, said one or more pieces of backing material designed and configured to protect said adhesive and to be peeled from said back side of said decal prior to use of said decal.

2. The decal assembly according to claim 1, wherein said decal is made of a light-retroreflective material.

3. The decal assembly according to claim 1, wherein said display incorporates one or more light-retroreflective elements.

4. A method of repairing or replacing a sign, comprising the steps of:
acquiring a decal assembly, comprising:
a decal having a front side and a back side, said front side printed with a display and said back side coated with an adhesive; and
one or more pieces of backing material covering said back side of said decal, said one or more pieces of backing material designed and configured to protect said adhesive and to be peeled from said back side of said decal;
Peeling the one or more pieces of backing material from said back side of said decal;
Aligning said back side of said decal with the front side of a sign that is to be repaired or replaced; and
Pressing and adhering said back side of said decal onto said front side of said sign that is to be repaired or replaced.

5. The method of claim 4, wherein the method further comprises the step of:
Cleaning said front side of said sign that is to be repaired or replaced prior to pressing said back side of said decal onto said front side of said sign that is to be repaired or replaced.

6. The method of claim 4, wherein the method further comprises the step of:
Cutting one or more openings through said decal, said one or more openings configured to provide clearance through said decal for hardware that may protrude from said sign that is to be repaired or replaced.

7. A decal assembly for repairing or replacing a sign, comprising:
a plurality of decals, each decal having a front side and a back side, said front side having a display and said back side coated with an adhesive; said plurality of decals being stacked, one upon another with the back side of one decal being attached to the front side of the next decal, and
one or more pieces of backing material covering said back side of the bottom-most decal of the stack of decals, said one or more pieces of backing material designed and configured to protect said adhesive and to be peeled from said back side of said back-most decal prior to use of said plurality of decals.
